(19) United States
(12) Patent Application Publication
(10) Pub. No.: US 2007/0295207 A1
(43) Pub. Date: Dec. 27, 2007

(54) ELECTROSTATIC COLLECTION DEVICE

(75) Inventors: RICHARD R. THOMAS, FOREST HILL, MD (US); FREEMAN SWANK, OLATHE, KS (US); ANDREW FAIRCHILD, OLATHE, KS (US)

Correspondence Address: SHOOK, HARDY & BACON LLP;INTELLECTUAL PROPERTY DEPARTMENT, 2555 GRAND BLVD, KANSAS CITY, MO, 64108-2613, US

(73) Assignee: SCEPTOR INDUSTRIES, INC., KANSAS CITY, MO (US)

(21) Appl. No.: 11/426,159

(22) Filed: Jun. 23, 2006

(51) Int. Cl. B03C 3/74

(52) U.S. Cl. 95/73; 95/74; 55/282.3; 55/DIG. 1; 96/28; 96/414

(57) ABSTRACT

Embodiments of the present invention relate to an electrostatic collection device and method for extracting impurities from gas. The collection devices includes at least one electrical field for charging particles, where the particles are in a gas, and at least one collection surface for collecting charged particles. The device further includes at least one heating element for heating the at least one collection surface to vaporize the collected particles.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

In many instances, it is necessary to determine impurities in a gas, such as air. For instance, collection and testing of a gas sample may be done to determine if any biological and chemical warfare agents are present in the sample. For instance, government facilities, mail rooms, high-profile events, transportation and urban areas may monitor the air for biological and chemical warfare agents.

Collection and testing of air may also be done to determine whether any environmental toxins are present in the air. For example, indoor and outdoor environments may be sampled to determine environmental impurities present in the air. Impurities may include, micro and submicron bioaerosols, target airborne pathogens, including viruses and bacteria, as well as some explosive vapors and certain chemicals.

Many current detection techniques require impurities in a gas, such as air, to be concentrated before analysis. Previous methods of concentrating impurities in air have employed filtering technology and collection of impurities in a liquid medium. These prior methods present serious disadvantages of both lowered extraction efficiency and are limited as to the type of particles that may be collected.

### SUMMARY

In one embodiment, a collection device for collecting particles from a gas is provided. The device comprises at least one electrical field for charging particles, where the particles are in a gas and at least one collection surface for collecting charged particles. The device further comprises at least one heating element for heating the at least one collection surface to vaporize the collected particles. In one embodiment, the collected particles are biological organisms that pyrolize when the collection surface is heated.

In another embodiment, a collection device for collecting particles from a gas is provided. The collection device comprises at least one passage defined by a wall and at least one electrical field in the at least one passage for charging particles, where the particles are in a gas. The device further comprises at least one collection post for collecting charged particles, where the at least one collection post is located within the at least one passage and at least one heating element for heating the at least one collection post to vaporize the collected particles.

In yet another embodiment, a method of extracting impurities from a gas is provided. At least one air passage defined by a wall and at least one electrical field within the at least one air passage are provided. Gas having particles through the at least one electrical field to charge the particles in the gas and at least some of the charged particles are collected onto a collection surface. The collection surface is heated to vaporize at least some of the collected particles.

In still another embodiment, a method for visual examination of impurities from a gas is provided. At least one air passage defined by a wall and at least one electrical field within the at least one air passage are provided. Gas having particles is passed through the at least one electrical field to charge the particles in the gas and at least some of the charged particles are collected onto a collection surface. A visual inspection of the collection surface is performed to view at least some charged particles collected on the collection surface.

### BRIEF DESCRIPTION OF THE SEVERAL VIEWS OF THE DRAWINGS

The present invention is described in detail below with reference to the attached drawing figures, wherein:

FIG. 1 is a perspective view of a collection device constructed in accordance with an embodiment of the invention;

FIG. 2 is a side plan view of a collection device constructed in accordance with an embodiment of the invention with a portion of the body device removed in accordance with an embodiment of the present invention;

FIG. 3 is an exploded view of a corona charging zone in accordance with an embodiment of the present invention;

FIG. 4 is a side plan view of a non-perforated collection post in accordance with an embodiment of the invention;

FIG. 5 is a side plan view of a perforated collection post in accordance with an embodiment of the present invention;

FIG. 6 is a graphical representation of collection efficiency of a collection device in accordance with an embodiment of the present invention;

FIG. 7 is a graphical representation of a sample collection cycle in accordance with an embodiment of the present invention;

FIG. 8 is a perspective view of a collection device constructed in accordance with an embodiment of the invention;

FIG. 9 is a perspective view of a collection device and corona charging zone constructed in accordance with an embodiment of the present invention; and

FIG. 10 is a perspective view of a collection device in accordance with an embodiment of the present invention.

### DETAILED DESCRIPTION

Embodiments of the present invention relate to an electrostatic device that utilizes electrostatics to collect particles from gas, such as air. The particles are collected onto a collection surface such as walls or a collection post to concentrate the particles. The particles collected may be analyzed by visual inspection of the collection surface and/or heating the collection surface to vaporize the particles for subsequent detection by a downstream collector. Target particles collected may include, but are not limited to, biologicals, such micron and submicron bioaerosols, molds, pollen, fungi, bacteria, viruses and bacteriophages, chemicals such as low vapor pressure chemicals (LVPCs), explosives, toxins and other particles.

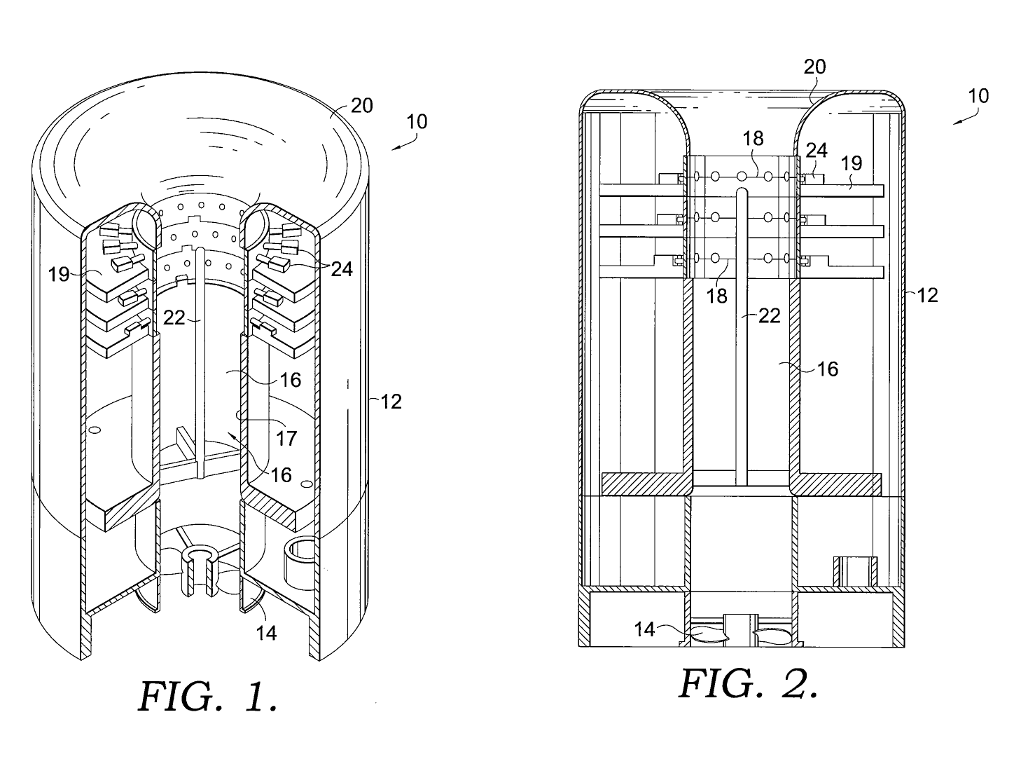

With reference to FIGS. 1 and 2, one embodiment the present invention relates to an electrostatic device 10 for the collection and concentration of particles. The device 10 comprises an air passage 16, at least one corona charging zone 18, a collection post 22, an air mover 14 and housing 12. The device 10 brings gas, such as air, into the primary air passage 16 utilizing the air mover 14, passing the air through primary air passage 16 and at least one charging zone 18 and forcing airborne particles onto collection post 22. The electrostatic device 10 concentrates particles in the air to a concentrically located post 22 to obtain particle concentration.

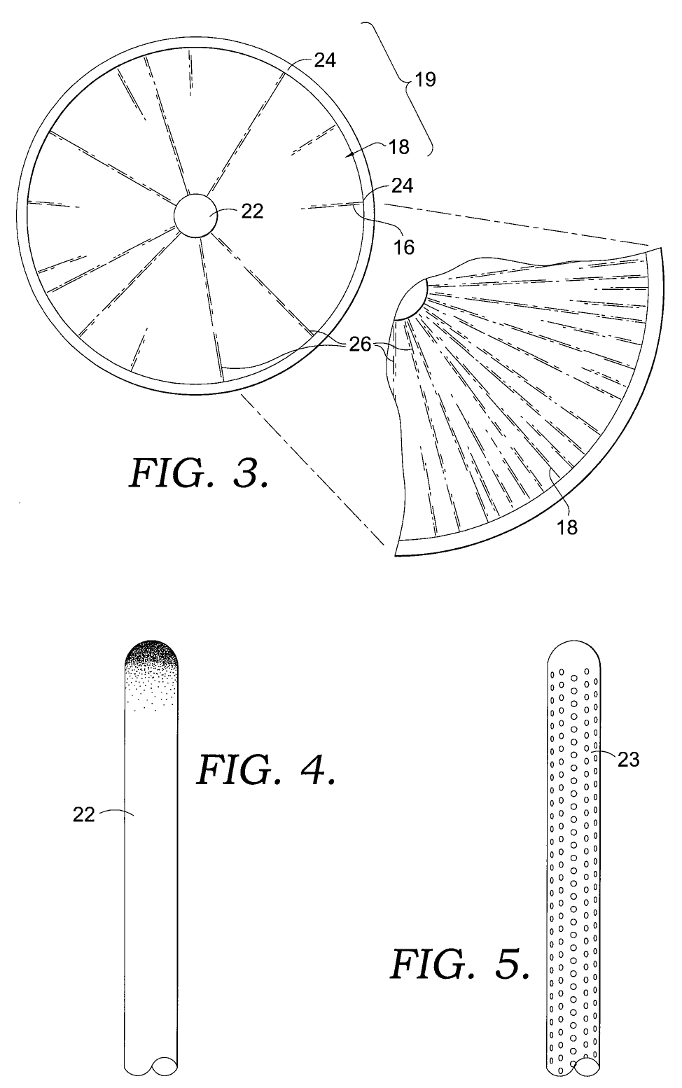

With reference to FIG. 3, a corona charging zone 18 is created by a plurality of electrodes 24. A series of electrodes 24 are spaced substantially equal angular distances on or within a duct 17 forming the primary air passage 16. Each series of electrodes 24 forms a row 19 of electrodes. The electrodes 24 are used to create multiple ion streams 26 forming a corona charging zone 18 within the primary air passage 16 surrounding collection post 22. The amperage for each electrode may be about 0.5 to 5 Microamps with a nominal of 1 microamp being preferred. The corona charging zone 18 may be a substantially uniform electrical field. In the present embodiment, the corona charging zone 18 is shown as being round, however, it may be a variety of shapes, including polygonal, square, rectangular and oval. It will be appreciated that charging zone may be created in a variety of ways. An exemplary charging zone 18 is described in described in U.S. Patent Application Publication No. 2004/0179322, the entirety of which is hereby incorporated by reference.

Multiple rows 19 of electrodes 24 may be used to help improve collection efficiency. Each additional row of electrodes 19 improves collection efficiency by increasing the plasma area of the corona charging zone 18. There are three rows 19 of electrodes 24 shown in FIGS. 1 and 2. It will be appreciated that device 10 may have any number of electrodes 24 and rows 19 of electrodes 24.

Exemplary collection post 22 is shown in FIG. 4. The exemplary collection post 22 in FIG. 4 is a non-perforated post that has a domed or curved hemispherical top. Collection post 22 may be of any diameter depending of the flow rate of the air through the air passage 16 and the voltage used to control the device 10. For instance, the post 22 may be about 0.125 to about 0.75 inches in diameter. In the electrostatic device 10, the majority of the charged particles are collected on the tip of the collection post 22. However, one of skill in the art will appreciate that the particles may be collected on any part of the collection post 22.

More than one post 22 may be located in the electrostatic device 10. The collection post 22, while shown as being round, may be polygonal, rectangular, square or any variety of other shapes. Round is preferred, however, to minimize the occurrence of reverse corona generation which can affect collection efficiency. The one or more collection posts 22 may be removable. It will be appreciated that the post 22 may be non-perforated or perforated.

To improve the particle collection, or enable the ability to collect vapors, on the surface of the collection post 22, a chemical adsorbent may be used to coat the surface of the collection post 22. Exemplary chemical adsorbents may include polymers such as polyether ether ketone and polytetrafluoroethylene.

Referring again to FIGS. 1 and 2, the air passage 16 may be formed by enclosure such as walls or a duct 17. While the air passage 16 of FIGS. 1 and 2 is formed by a round duct, the primary air passage may be any variety of shapes including polygonal, square, rectangular and oval. The primary air passage 16 surrounding the collection post 22 may any size necessary for collection. In one embodiment, the air passage 16 is about 1-2 inches in diameter and the collection post is about 0.125 to 0.75 inches in diameter.

Housing 12 encases the air passage 16, corona charging zone 18, collection post 22 and air mover 14. It will be appreciated that housing 12 may be any type including modular housing. Air mover 14 may be any variety of air movers, including fans. Exemplary air movers include commercial, of the shelf fan, such as small muffin fans like those generally used to aid in the cooling of computer processors.

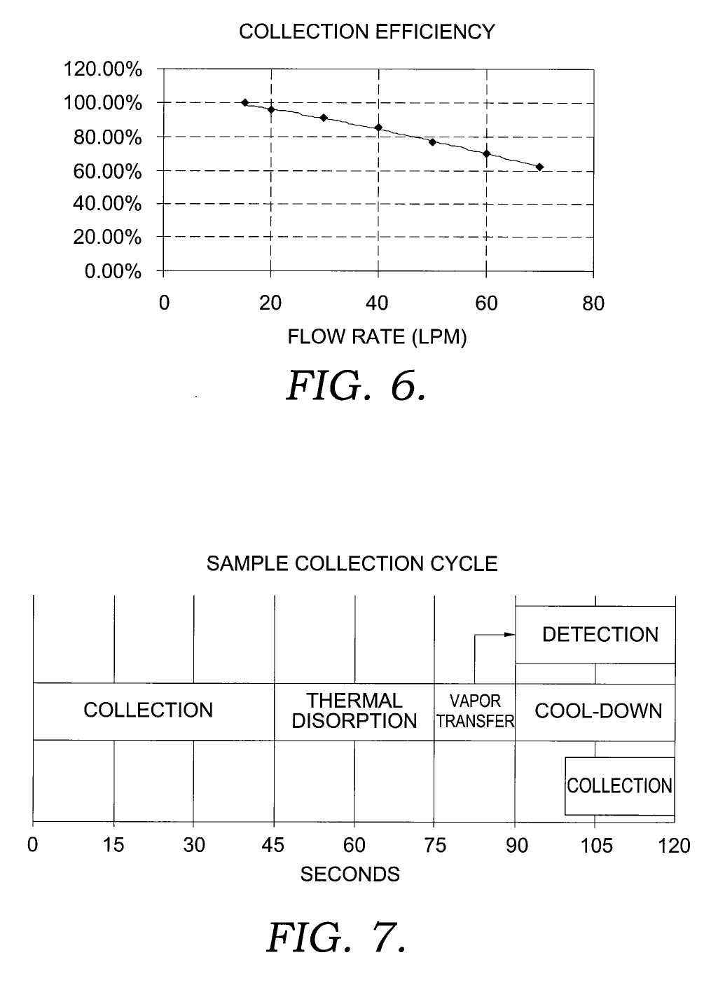

Utilizing a muffin fan, the sampling flow rate for the collection device 10 can be varied from about 20 to 100 L/min with a collection efficiency about >90% for 1 μm particles at a flow rate of about 20 L/min. FIG. 6 shows efficiency vs. flow rate for about 2.3 μm particle diameter for one embodiment. As can be seen from FIG. 6, exemplary collection efficiency is near linear with flow rate. Collection efficiencies range from about 60% to 80% for particle diameters between about 0.5 μm and 2 μm, respectively. The target particulate size is in the range of about 0.5 to 10 μm in diameter. It will be appreciated that the flow rate, collection efficiency and target particle size collected by device 10 may vary dependent on device configuration.

A variety of power supplies may be utilized to power collection device 10. The power supplies include internal and external power supplies. The power supply may power the air mover 14, electrodes 24, heating of the collection post 22 and removal of the vaporized particles.

After collection is completed, particles collected on the collection post 22 may be analyzed by 1) visual inspection of the collection post 22 and/or 2) heating the collection post 22 to vaporize the collected particles for subsequent detection by a downstream collector.

For visual inspection, the particles are concentrated onto small collection surface, such as collection post 22, for visual inspection. The decreased size of the collection surface allows more collected particles to be viewed by visual inspection. Visual inspection may be aided by the use of microscopes, raman laser interrogation, UV spectroscopic techniques and the like.

The heating of the collection post 22 after collection converts collected particles into a vapor form usable by detectors, such as chemical detectors, mass spectrometry (such as a MEMS mass spectrometer), and ion mobility spectrometry. The detectors may be part of the collection device 10 or may be located separate from the collection device 10.

The heating method used to heat the collection post 22 may vary depending on the target particle(s) to be vaporized for collection. Different particles will vaporize at different temperatures and vapor pressure. For instance, the collection post 22 may be continuously heated to just below the vaporization temperature of the target material during and/or after collection. This is done to avoid concentration of “interferent” particles while still allowing the concentration of the target particles. Alternatively, the collection post 22 may be heated slowly after collection. For quick vaporization of collected particles, the collection post 22 may be rapidly heated after collection. The collection post 22 may be heated in stages at different temperatures to obtain the vapor from selected particles at varying time periods or to find out more information about the collected particles. The vaporization temperature of the particles depends on its chemical makeup, for instance readily available pesticides may vaporize between 160 and 250° C., while biological organisms may pyrolize at or above 400° C.

Heating of collection post 22 may be done in a variety of ways including, but not limited to, an internal cartridge heater, coil heating, contact heating, and laser ablation of particles on collection surface.

By way of example, and not by limitation, a COTS heating element is utilized to heat the collection post after the collection process is complete. Because of the small size and low mass of the collection post 22 as well as heating unit, the ramp rate is targeted to be 15° C,/second enabling the post to change from about 0° C. to 200° C. in less than 15 seconds. After the collection post 22 has met the targeted maximum temperature it dwells for a brief pre-determined period of time to ensure that all material has been vaporized.

Vaporization of particles can occur in fixed air volume contained or moved through the air passage 16. The concentration of vapor from the particles will depend on the airflow rate.

Once the particles have been vaporized, the resulting vapor is drawn through either an external port in the device 10 or through the existing outlet by the air mover 14, or through perforations in the collection post for subsequent detection. The transport of the vapor will be controlled either through a secondary port on the side of the device 10, or by the primary exit by re-activating the air mover 14.

By way of example, an not by limitation, in order to meet a target time of about two minutes for start to alarm for detection—the collection, concentration, and thermal desorption of target particles is less than about 1 minute and 30 seconds. To achieve this target, the projected maximum cycle time for each phase of the collection device is about 45 seconds for collection/concentration, about 30 seconds for thermal desorption, (heating of collection post 22) about 15 seconds for vapor transfer and about 30 seconds for the collection post 22 to cool-down. This exemplary cycle is shown in FIG. 7. In some instances, to reduce the time to the next detection cycle, collection may resume during the cool-down portion. This overlap can reduce the perceived collection cycle and ensure that a two minute time limit is met consistently. It will be appreciated, however, that the time for collection/concentration, heating of collection post 22, vapor transfer and cool-down may vary according to need and may be any amount of time. As such, heating and collection may occur continuously and concurrently which would allow continuous collection and conversion of collected material, albeit at the expense of concentration performance.

The exemplary collection post 23 in FIG. 5 is a perforated collection post 23. The perforated collection post 23 may allow for a more concentrated sample to be collected. It will be appreciated that device 10, when used with a perforated or nonperforated post may be any size. For instance, the device 10 utilized with a perforated post may be less than about twenty cubic inches. With the perforated collection post 23, the primary airflow is approximately 50 L/per minute and flows past the perforated collection post 23 located centrally in the flow path. A small portion of the air flows through the perforated collection post 23. The particles suspended in the air become charged as they near the corona charging zone 18 formed by the electrodes 24.

The charged particles are attracted by electrostatic forces and are collected on the perforated collection post 23 in the center of the device 10. The particles are collected on the perforated post 23 until the desorption cycle is initiated. After the post 23 is heated, vapors are drawn through the perforated post 23 and directly into a transfer tube connected at the base of the post and in communication with the inside of the post (not shown), rather than being allowed to fill the primary air passage 16 and device 10 volume before being drawn off. This allows for increased concentration of particles in the desorption vapor. The vapor may then be transferred to a vapor based detection system, or collected in standard available chemical sampling sorbent tubes for storage, transport, or later analysis.

The perforated post may be heated in a variety of ways including a coiled heater that allows the perforated collection post 23 to be heated quickly to convert the captured particles into vapor rapidly. The perforated collection post 23 may be heated after collection, continuously or in steps. Any number of rows of electrodes may be utilized, preferably, with a perforated post 23 two rows of electrodes are utilized to reduce costs and power consumption.

It will be appreciated that the electrostatic device 10 described typically uses lower power than other electrostatic applications, primarily due to a current control feedback method which maintains proper power to the array. Furthermore, the radial collector geometry of the electrostatic device 10 shown in FIGS. 1 and 2, allows for small collection area improving concentration of the collected particles.

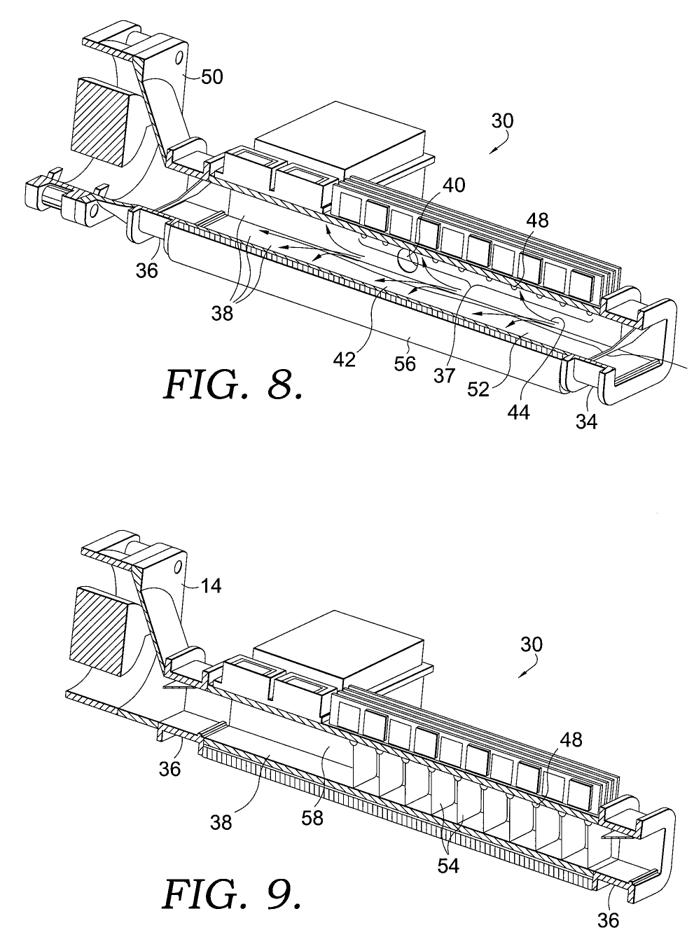

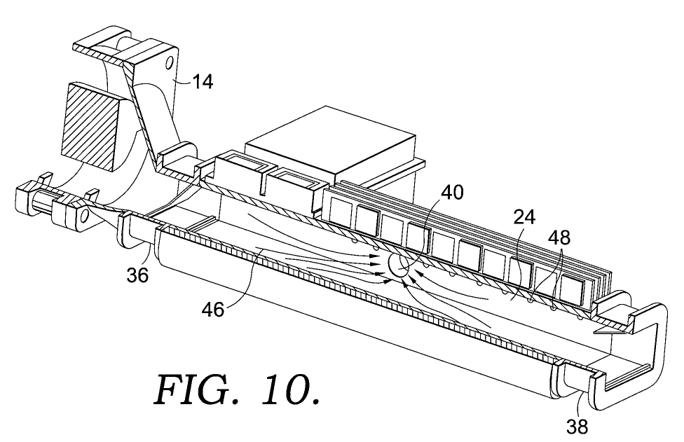

With reference to FIGS. 8, 9 and 10, in alternative embodiment the present invention, an electrostatic device 30 for the collection and concentration of particles is shown. The electrostatic device 30 utilizes a long rectangular system geometry and a linear electrode array 37.

The device 30 comprises an air passage 52, at least one corona charging zone 54, a collection surface 38, an air mover 50, shutters 34 and 36 and housing 56. The device 30 brings a gas, such as air, into primary air passage 52 utilizing air mover 50. Air mover 50 draws gas, such as air, through the air passing 52 with the shutters 34 and 36 open. The electrodes 48 create at least one corona 54 as shown in FIG. 9. For example, at least one corona charging zone 54 emanates from each electrode 48 and terminates at collection surface 38. As air is flowed 44 through air passage 52, particles in the air are charged by the at least one corona charging zone 54 and are attracted to the collection surface 38 adjacent and opposite to corona electrodes 48.

With reference to FIG. 9, each corona charging zone 54 is created by at least one electrode 48. A substantially uniform corona charging zone 54 is created between each electrode 48 and the opposite collection surface 38. In this embodiment, electrodes 48 are positioned linearly 37 substantially equidistance from each other along a wall 58. Wall 58 creates the primary air passage 52. The corona charging zone 54 may be a substantially uniform electrical field. In the present embodiment, the corona charging zone 54 is shown as being the same shape as the wall 58 creating air passage 52. The corona charging zone 54 may be a variety of shapes, including polygonal, square, rectangular and oval. A three dimensional effect of the corona charging zone 54 may be created near wall 58 adjacent to the electrodes 48 and cause corona charging zone 54 to warp towards wall 58 adjacent to electrodes 48. An exemplary charging zone 58 is described in U.S. Patent Application Publication No. 2004/0179322.

Air passage 52 is formed by an enclosure such as walls 58 or a duct. Air passage 52 may be any shape including, round, polygonal, square, rectangular and oval. The air passage 52 may be any size necessary for collection.

The walls 58 or the primary air passage 52 may also serve as a collection surface 38 as shown in FIGS. 8-10. It will be appreciated that collection surface 38 may be formed by a single wall or duct or may be formed by multiple walls or pieces. This collection surface may also be perforated, if desired. To improve the particle collection on the collection surface 38, an adsorbent may used to coat the collection surface 38. The adsorbent may enable the collection of gas and vapors on collection surface 38. Exemplary adsorbents may include polymers such as polyether ether ketone and polytetrafluoroethylene.

Housing 56 encases the primary air passage 52, one or more corona charging zones 48, collection surface 38 and air mover 50. It will be appreciated that housing 56 may be any type including modular housing. Air mover 50 may any variety of air movers, including fans. Exemplary air movers include a COTS fan.

Utilizing an air mover, the sampling flow rate for the collection device 30 can be varied depending on the efficiency needed. It will be appreciated that the flow rate, collection efficiency and target particle size may vary.

A variety of power supplies may be utilized to power the collection device 30. The power supplies include internal and external power supplies. Exemplary power supplies may power one or more of the air mover, electrodes, heating of the collection surface and removal of vaporized particles.

After collection is completed, particles collected on the collection surface 38 may be analyzed by 1) visual inspection of the collection surface and 2) heating the collection surface to vaporize the collected particles for subsequent detection by a collector.

For visual inspection, the particles are concentrated on the collection surface 38 for visual inspection. Visual inspection may be aided by the use of microscopes and the like.

The heating of the collection surface 38 after collection converts collected particles into a vapor form usable by detectors, such as chemical detectors, mass spectrometry, ion mobility spectrometry, and differential mobility spectrometry. The detectors may be part of the collection device or may be located separately from the collection device 30.

The heating method used to heat the collection surface 38 may vary depending on the target particle(s) to be vaporized for collection. Different particles will vaporize at different temperatures and vapor pressure. For instance, the collection surface 38 may be continuously heated during and/or after collection, just below the vaporization temp of the target material to avoid concentration of “interferent” particles while still allowing the concentration of target particles. The collection surface 38 may be heated slowly after collection. For quick vaporization of the collected particles, the collection surface 38 may be rapidly heated after collection. The collection surface 38 may also be heated in stages and at different temperatures to obtain the vapor from selected particles at varying time periods or to find out more information about the collected particles.

It will be appreciated that conversion of collected particles on collection surface 38 may occur continuously or after air mover 50 has stopped. When conversion of captured particles on collection surface 38 is desired after air mover 50 is stopped, collection surface 38 is heated to drive off the collected particles as a vapor with the shutters 34 and 36 closed to minimize escape of the desorbed vapor.

The heating of collection surface 38 may be done in a variety of ways, including, but not limited to, utilizing an internal cartridge heater and/or a coil heater, contact heating, laser ablation of particles on the collection surface.

Once the particles are driven off as vapor, the vapor 46 may be transferred via transfer port 40. The vapor 46 may be transferred to a variety of detectors or may be collected as a sample. Although transfer port 40 is shown as being centrally located in the collection device 30, it will be appreciated that the transfer port 40 may be located anywhere within the device 30, upstream of air mover 50. Device 30 allows for a high collection area and high capture and conversion efficiency.

From the foregoing, it will be seen that this invention is one well adapted to attain all the ends and objects hereinabove set forth together with other advantages which are obvious and which are inherent in the structure. It will be understood that certain features and subcombinations are of utility and may be employed without reference to other features and subcombinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

The invention claimed is:

1. A collection device for collecting particles from a gas, the device comprising:
at least one electrical field for charging particles, wherein the particles are in a gas;
at least one collection surface for collecting charged particles; and
at least one heating element for heating the at least one collection surface to vaporize the collected particles.

2. The collection device of claim 1, wherein each of the at least one electrical fields is a corona charging zone.

3. The collection device of claim 2, wherein each of the corona charging zones is formed by a plurality of electrodes.

4. The method of claim 3, wherein the plurality of electrodes are radially spaced substantially equal angular distances within a duct forming a primary air passage.

5. The method of claim 4, wherein the at least one collection surface is a post located within the primary air passage.

6. The method of claim 5, wherein the plurality of electrodes are linearly spaced along a wall that helps form an air passage.

7. The method of claim 6, wherein each of the electrical fields is created between each of the electrodes and the at least one collection surface.

8. The device of claim 7, wherein the at least one collection surface is the surface of the wall.

9. The device of claim 1, further comprising:
an air mover for drawing air into the collection device and through the at least one electrical field.

10. The device of claim 1, wherein the charged particles are forced onto the at least one collection surface.

11. The device of claim 1, wherein the at least one collection surface is coated with a chemical adsorbent.

12. The device of claim 1, wherein the collected particles are biological organisms that pyrolize when the at least one collection surface is heated.

13. A collection device for collecting particles from a gas, the device comprising:
at least one passage defined by a wall;
at least one electrical field in the at least one passage for charging particles, wherein the particles are in a gas;
at least one collection post for collecting charged particles, wherein the at least one collection post is located within the at least one passage; and
at least one heating element for heating the at least one collection post to vaporize the collected particles.

14. The device of claim 13, wherein the at least one collection post is nonperforated.

15. The device of claim 13, wherein the at least one collection post is perforated.

16. The device of claim 13, wherein the at least one collection post is removable from the at least one passage.

17. The device of claim 13, wherein the vaporized particles are drawn through the perforated post to be removed from the device.

18. The device of claim 13, wherein the collected particles are biological organisms that pyrolize when the at least one collection surface is heated.

19. A method of extracting impurities from a gas, said method comprising:
providing at least one air passage defined by a wall;
providing at least one electrical field within the at least one air passage;
passing gas having particles through the at least one electrical field to charge the particles in the gas;
collecting at least some of the charged particles onto at least one collection surface; and
heating the at least one collection surface to vaporize at least some of the collected particles.

20. The method of claim 19, wherein the collection surface is heated by one of an internal cartridge heater, coil heating, contact heating and laser ablation of particles on collection surface.

21. The method of claim 19, wherein the collection surface is heated continuously during and after the collection of the charged particles.

22. The method of claim 19, wherein the collection surface is heated after the collection of the charged particles.

23. The method of claim 19, wherein the collection surface is heated in stages after the collection of the charged particles

24. The device of claim 19, wherein the collected particles are biological organisms that pyrolize when the at least one collection surface is heated.

25. A method for visual examination of impurities from a gas, the method comprising:
providing at least one air passage defined by a wall;
providing at least one electrical field within the at least one air passage;
passing gas having particles through the at least one electrical field to charge the particles in the gas;
collecting at least some of the charged particles onto at least one collection surface; and
performing visual inspection of the at least some charged particles collected on the at least one collection surface.

26. The method of claim 25, wherein the visual inspection is aided by use of a microscope.
